(19) United States
(12) Patent Application Publication
(10) Pub. No.: US 2013/0068770 A1
(43) Pub. Date: Mar. 21, 2013

(54) LINER FOR TRASH CONTAINER

(71) Applicant: Suzanne S. Mays-Hornung, Key Colony Beach, FL (US)

(72) Inventor: Suzanne S. Mays-Hornung, Key Colony Beach, FL (US)

(21) Appl. No.: 13/675,624

(22) Filed: Nov. 13, 2012

Related U.S. Application Data
(63) Continuation-in-part of application No. 12/713,601, filed on Feb. 26, 2010, now abandoned.
(60) Provisional application No. 61/157,418, filed on Mar. 4, 2009.

(51) Int. Cl. B65F 1/06; B65B 5/00

(52) U.S. Cl. CPC B65F 1/06; B65B 5/00
USPC 220/495.11; 53/452

(57) ABSTRACT

A liner for a waste basket or trash container having flexible side walls, a top portion and a bottom portion. The cross-section of the liner closely conforms to the cross-section of the container. An elastic band is attached circumferentially about the top portion of the liner. The elastic band retains the top portion of the liner to the outer wall of the top of the trash container. The liner is color coordinated with the decor of the room where the trash container is disposed.

### CROSS REFERENCE TO RELATED APPLICATIONS

The present application is a Continuation-in-Part of U.S. patent application Ser. No. 12/713,601, filed on Feb. 26, 2010; which was related to and claimed priority from U.S. provisional application Ser. No. 61/157,418, filed Mar. 4, 2009, the disclosure of which are hereby incorporated herein in their entireties.

### BACKGROUND

1. Field

One or more embodiments of the present application is directed to liners for trash containers and more particularly to liners with an elasticized top and a reinforced bottom which conform to the shape of the trash container. One or more embodiments of the present application is directed to liners for trash containers and more particularly to liners with an elasticized top and a reinforced bottom which conform to the shape of the trash container.

2. Description of Related Art

The large variety of trash can sizes and shapes has prompted trash liner manufacturers to offer a few “one size-fits-all” liner sizes that ultimately do NOT really fit popular can sizes (i.e., “Tall” liner size). This adds to the unprofessional appearance of the trash can liner. The size of the bag ends up being too small or too big. The result is a trash can liner that falls into the can; tears; or hangs down over the edge.

The shape of currently available trash can liners does not fit correctly into the trash cans. The shape of the bottom of the hag simply does not match the shape of the bottom of the trash can. As the bag fills with trash, the bag is pulled further into the can because the hag is sinking into the can—the corners that do not match the bottom edges of the can ultimately sink down, pulling the top edge of the trash can liner down with it. To compound this problem, currently available trash can liners do not fit the top of the can in a way that they form-fit the top edge of the trash can. The result is a trash bag that has sunk into the can where it is necessary to continually reach a hand in and pull the top edges back up over the trash can. This is unattractive, unsanitary and, as will be described, unnecessary.

The large variety of trash can sizes and shapes has prompted trash liner manufacturers to offer a few “one size-fits-all” liner sizes that ultimately do NOT really fit popular can sizes (i.e., “Tall” liner size). This adds to the unprofessional appearance of the trash can liner. The size of the bag ends up being too small or too big. The result is a trash can liner that falls into the can; tears; or hangs down over the edge.

The shape of currently available trash can liners does not fit correctly into the trash cans. The shape of the bottom of the hag simply does not match the shape of the bottom of the trash can. As the bag fills with trash, the bag is pulled further into the can because the hag is sinking into the can—the corners that do not match the bottom edges of the can ultimately sink down, pulling the top edge of the trash can liner down with it. To compound this problem, currently available trash can liners do not fit the top of the can in a way that they form-fit the top edge of the trash can. The result is a trash bag that has sunk into the can where it is necessary to continually reach a hand in and pull the top edges back up over the trash can. This is unattractive, unsanitary and, as will be described, unnecessary.

In some other approaches, perforated edges are used to join individual liners which tend to be hard to pull apart and creates a rough edge at the top of the next liner.

### BRIEF SUMMARY

In accordance with the teachings of the present disclosure there is disclosed in combination with a waste basket or other trash receptacle or container, a liner having a top perimeter and a bottom portion. An elastic means is retained on the top perimeter of the liner forming a narrow band thereabout. The liner may be removably inserted in and retained on the trash receptacle or container and fitted in place within the container. The liner has a transverse cross-section conforming closely to the container, thereby avoiding bulges or gaps between the liner and the container and wherein material deposited in the trash receptacle or container are received in the liner.

In further accordance with the teachings of the present application, there is disclosed a disposable removable liner for a container. The container has surrounding walls, a bottom and an open top. The liner comprises flexible film sidewalls, a top portion and a bottom portion. The bottom portion has a planar reinforcement and a transverse cross-section conforming closely to the bottom of the container. When the liner is disposed in the container, the sidewalls of the liner are disposed in the container without bulges or gaps between the side walls of the liner and the walls of the container. An elastic means is attached circumferentially about the top portion of the liner. When the liner is fitted in the container, the elastic means holds the top portion of the liner to the outer wall of the container. The liner is color coordinated with the decor of the room in which the container is disposed.

In addition, there is disclosed a method of collecting trash in a waste basket or other trash receptacle or container, wherein the container has a transverse cross-section. The method comprises the steps of providing a disposable liner having a transverse cross-section which substantially conforms to the cross-section of the container, unfolding the liner and inserting the liner into the container. The liner, when unfolded, lies neatly within the container without bulges or gaps and conforms to the base of the container. The top of the liner is provided with an elastic band, and the elastic band is snapped over a peripheral lip of the container.

Despite the extensive research and development devoted to liners for trash containers, as exemplified above, the disadvantages and deficiencies of the prior art have persisted for many years and there is a need for improvement.

### BRIEF DESCRIPTION OF THE DRAWINGS

FIG. 1 is a perspective view of a trash bag liner of the prior art disposed in a trash container.

FIG. 2 is a partial cut-away view of a trash bag liner of the prior art showing a heavy object in the liner collapsing the liner.

FIG. 3 is a perspective view of the trash bag liner of the present invention in a trash container.

FIG. 4 is a partial cut-away view of the trash bag liner of the present invention showing a heavy object not affecting the liner.

FIG. 5 is a cross-section view of the present invention in a container showing a reinforced bottom portion.

FIG. 6 is a cross-sectional view taken across the lines 6-6 of FIG. 5.

FIG. 7 is a cross-section view of the top perimeter of the trash bag liner having a thin elastic band taken across the lines 7-7 of FIG. 5.

FIG. 8 is a partial cut-away view of the trash bag liner of the present invention in a circular trash container.

FIG. 9 is a top plan view of the trash bag liner of the present invention conforming to the shape of the trash container.

FIG. 10 is a top view of a square trash container having a trash liner therein conforming to the shape of the trash container.

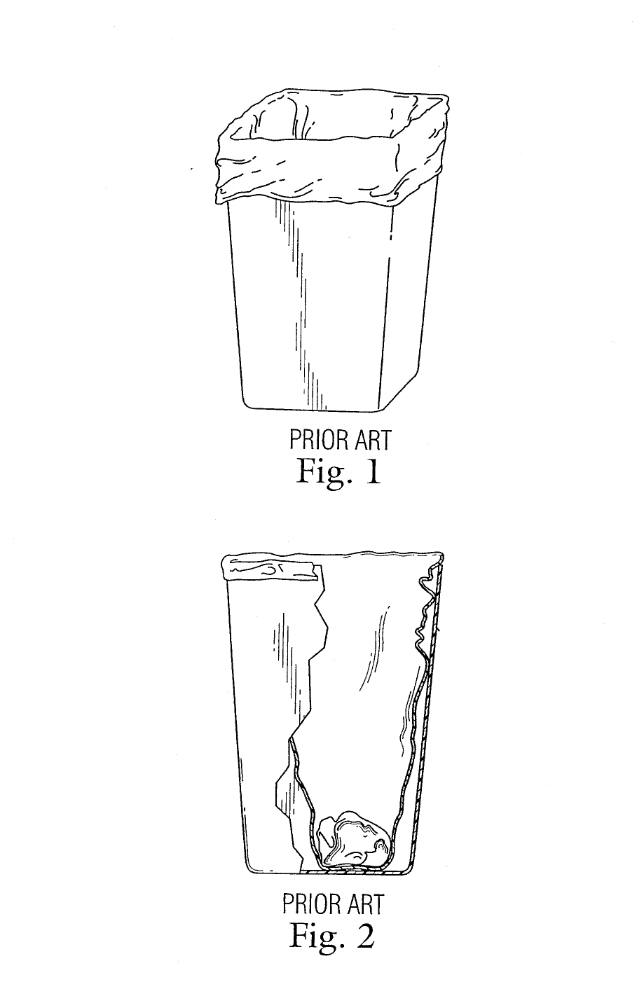

### DESCRIPTION

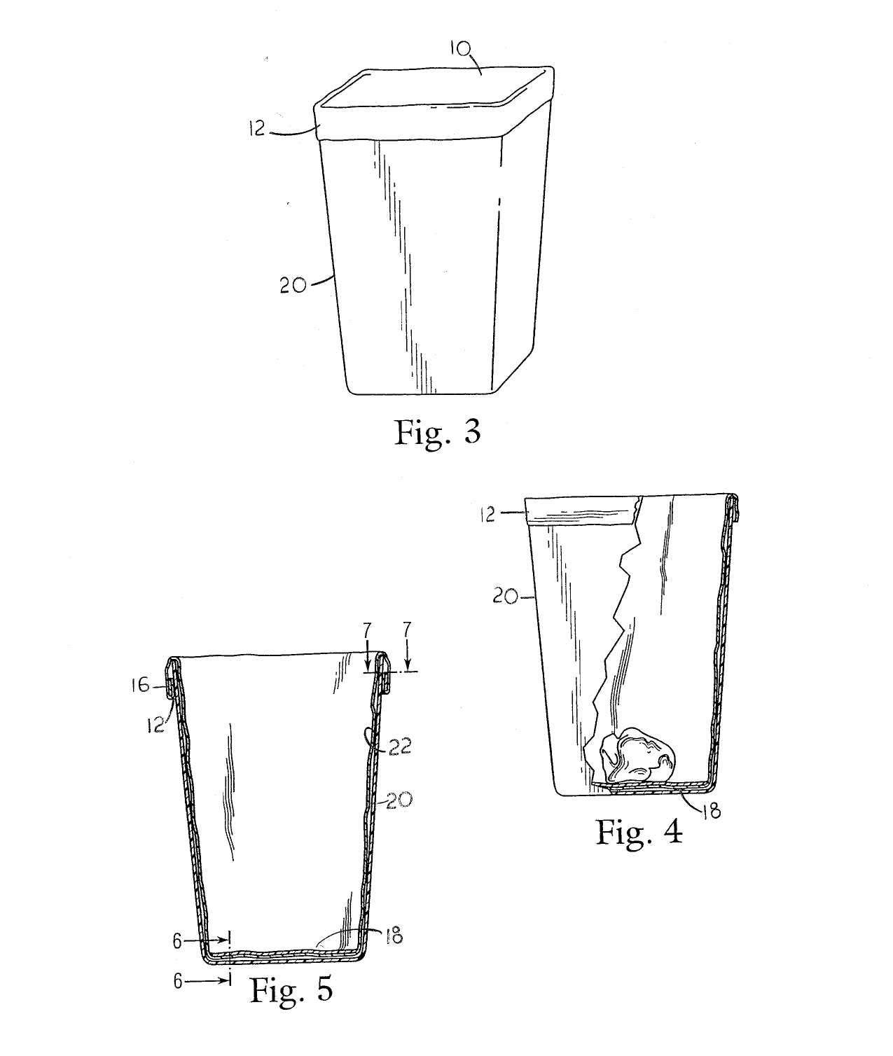

The improved trash bag liner 10 is formed having walls of plastic film 22 and has a top perimeter 12 which is openable to receive trash and has a closed bottom portion 14 (FIGS. 3-5). An elastic band 16 is secured around the top perimeter 12 of the trash bag liner 10. It has been found that an elastic marketed as “stretchrite”® has been used successfully (FIG. 7). This material is usually used in sewing and is a continuous strip approximately ⅜″ wide. Other elastic materials known to persons skilled in the art may be used.

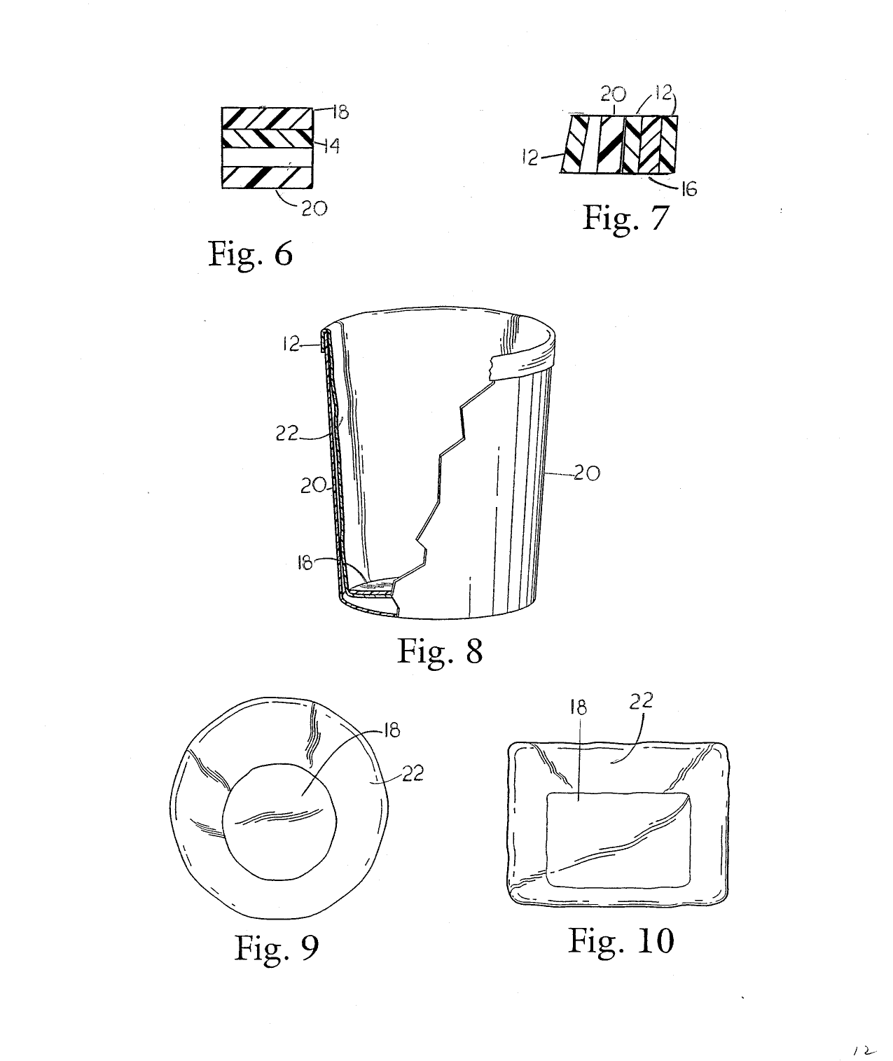

The bottom portion 14 of the trash bag liner is reinforced 18 or formed with an integral double thickness to assure that the liner 10 is sturdy enough to retain a full load or heavy object and conforms with the container (FIG. 6). In a preferred design, a layer of plastic film is disposed interiorly or exteriorly on the bottom 14 of the liner to form the double thickness. The layer may be sealed, fused or adhered to the bottom of the liner. When the liner with the reinforced bottom 18 is fitted in the container, the reinforced bottom 18 is disposed in contact with the bottom of the container and there are no gaps or bulges between the liner 10 and the container 20. Due to the additional thickness of the reinforced bottom, the liner is more easily placed in the container.

The trash bag liner 10 may be formed of a shape with conforms to the shape of the trash container 20. This shape may be circular, oblong, square, rectangular or of other configurations (FIGS. 8-10). Further, the trash bag liner may have a tapered shape with the top perimeter 12 having a larger cross-section than the bottom portion 18.

In use, the stored liner 10 is unfolded, the bottom portion 14 of the liner 10 is placed in the trash container 20 and the perimeter of the top of the liner is snapped around the lip of the trash container 20. The liner snuggly fits around the top of the trash container 20 and the liner 10 is disposed in the trash container avoiding bulges or gaps between the liner and the container. A sanitary, attractive closure is formed.

The trash liner 10 is easily removed by expanding the elastic band 16 and lifting the liner from the trash container. Due to the reinforced bottom, the liner resists tearing even if there is a heavy load within the liner.

The trash bag liner further is formed from colored plastic to match the decor of the room in which the trash container is placed. This maintains a professional appearance in a business or non-commercial environment.

The liners may be formed in small, medium, large and extra large to be usable with popular trash containers found in the market.

A liner for a waste basket or other trash receptacle or container made from plastic film, having an open top portion that encases an elastic plastic band, flexible side walls and a bottom portion that is formed, doubled in thickness and integral with the liner.

One or more embodiments of the present invention of a liner for a waste basket or trash receptacle or container. In general, living in the twenty-first century there are a wide variety of shaped containers, waste baskets and trash receptacles, that are available on the market, that are used everyday, everywhere and in everyone's lives: i.e. homes, schools, offices, hospitals, private and public bathrooms, waiting rooms, sidewalk, at parks, grocery stores, and malls, just to name a few.

In one or more embodiments of the present invention of a liner it is simplified so that anyone can use it easily and in a timely fashion inserting and dispensing of said liner, it is form-fitted with an open perimeter, it has flexible sidewalls and a shaped bottom that is double thickness and integrated with the liner.

The liner's body is made of plastic film. The top circumference encases a narrow elastic plastic strip that is heat sealed together at both ends thus creating an elastic plastic band. The circumference of the top of the liner is longer than the circumference of the elastic plastic band. The elastic plastic band is in a stretched state of two to eight inches or there about. The elastic plastic band is not physically connected to the film's body thus enabling the elastic plastic band to move freely within the encasement, and ultimately enabling the liner's top perimeter to form fit the various geometric shaped waste baskets and other receptacles and containers.

The liner has flexible sidewalls and a bottom portion that is double in thickness and integral with the liner.

A rectangular liner;
Description of the making of a rectangular liner. The liner's body is made from a plastic film in which there are two elongated rectangular shaped pieces. A strip of elastic plastic that when heat sealed at both ends creates an elastic plastic band where it is encased in an open hem, creating an open top. The liner has flexible side walls and a rectangular shaped bottom that is double in thickness and integral with the liner.
   A. Piece 1—a piece of plastic film that is elongated and rectangular in shape, with two side edges and two end edges. This piece is wider in width than the second piece of plastic film
   B. Piece 2—a piece of plastic film that is elongated and rectangular in shape with two side edges and two end edges. This piece is narrower in width than piece one and is longer in length than the first piece of plastic film.
   C. Taking piece one of the elongated rectangular shaped plastic film and placing piece two of the elongated rectangular shaped plastic film on top of piece one centered perpendicularly.
   D. Heat sealing the side four edges that overlap in the center. Thus creating a bottom of a liner that is double in thickness, rectangular shaped and integral with the liner.

Another preferred method to heat seal the overlapped pieces of plastic film is to heat seal and compress both rectangular pieces together as if to have one piece of plastic film that is together, shaped rectangular to create the bottom of the liner.

E. Bringing the rectangular bottom's top elongated edge in an upright position, enables folding over one half of piece one over the other half of piece one, so that piece one's edges are exposed and equal in length.
F. Than folding inward piece two's halves so that they meet piece two side edges to piece one's side edges. Thus having all four top edges exposed and equal in length.
G. Heat sealing piece one's side edges to piece two's side edges, heat sealing all four edges together. Creating flexible side walls of a rectangular liner with an open top that has exposed edges and all ends are equal in length.
H. A narrow strip of clear light weight elastic plastic which is roughly ⅜ inches in width that could be ⅛ inches to 8/8 inches in width there about and added thickness can be used if warranted (used for different sizes and shaped liners). The brand ‘Stretchrite®’ is used in the art of sewing and is made from 100 percent polyurethane. It is thin, soft, clear and stretchy. When used in the art of sewing it is made to endure every day wear, it retains its strength and elasticity. Also having the ability to withstand 200 degrees Fahrenheit in temperature and adding the durability to stretch three to four times in length. Other material known to persons skilled in the art maybe used.
I. The narrow strip of elastic plastic has two side edges, and two end edges.
J. Taking the narrow strip of elastic and heat sealing the two end edge together to create and elastic plastic band.

Another preferred method of creating the elastic plastic band using elastic plastic narrow strips:

1. Having two narrow strips of elastic plastic
2. Strip one having two side edges, two end edges and is equal in length as strip two
3. Strip two having twoside edges, two end edges and is equal in length as strip one
4. Heat sealing strip one's two ends together with strip two's two ends together, thus creating an elastic plastic band.
K. The circumference of the top of the liner is larger than the circumference of the elastic plastic band.
L. The elastic plastic band is in a slightly stretched state of two to eight inches or there about. In at least some embodiments, the size of the band in a slightly stretched state is dependent on the size of the liner.
M. Placing the slightly stretched elastic plastic band over the liner's opened exposed top edges, in order to bring down the plastic film edges over the elastic plastic band and heat sealing, creating an open hem. Having the elastic plastic band encased as such, it is able to move freely within the hem in which also ensures the fit of the perimeter of various geometric shapes trash receptacles or waste baskets or containers.

A rectangular liner

Another method of an embodiment of the present invention of a liner for a waste basket, trash receptacle or container. The embodiment is made of plastic film, having an opened top portion that encases as elastic plastic band, flexible side walls, and a bottom portion that is rectangular in shape, double in thickness and integral with the liner.

In general there are two elongated rectangular shaped pieces of plastic film. Each piece has two side edges, a top edge and a bottom edge. The liner has flexible film sidewalls and a bottom that is rectangular in shape and integral with the liner. Also at the top perimeter of the rectangular liner, there is one elastic plastic band that is encased in the hem.

A. There are two pieces of plastic film that are elongated and rectangular in shape and equal in size.
B. Piece #1—a piece of plastic film that is elongated, rectangular in shape and has two side edges, a top edge and a bottom edge. Also equal size as piece two.
C. Piece #2—a piece of plastic film that is elongated, rectangular in shape, and has two side edges, a top edge and a bottom edge. Also equal in size as piece one
D. Taking piece one of the elongated rectangular plastic films at its side edges and taking piece two of the elongated rectangular plastic at its side edges and heat sealing them together, at their edges.
E. Thus creating the liners body that has exposed bottom edges, exposed top edges and are equal in lengths.
F. Bottoms for the liner can be manufactured prior to ensure they are ready for installation on the liner's body. The bottoms can be changed in material, thickness, shape, style, size, or any other feature that is warranted.
G. The bottom of one or more embodiments of the present invention uses the same plastic film throughout the design, but is doubled in thickness, shaped rectangular and is flat. The thickness of the plastic film helps gravity to pull the liner toward the bottom of the receptacle being used.
H. The rectangular bottom for the liner has two long side edges and two short side edges and is double in thickness.
I. Taking the plastic films body's two side seamed bottom edges and centering in the middle of short side edges of the rectangular plastic film bottom in order to heat seal the entire bottom edges of the body's liner to the entire rectangular plastic film's bottom four side edges. Thus creating a rectangular liner with an open top perimeter, flexible side walls and a rectangular bottom that is double in thickness, and having a transverse cross-section which substantially conforms to the cross-section of the container or trash receptacle or waste basket.
J. A narrow strip of clear light weight elastic plastic which is roughly ⅜ inches in width that could be ⅛ inches to 8/8 inches in width there about and added thickness can be used if warranted (used for different sizes and shaped liners). The brand ‘Stretchrite®’ is used in the art of sewing and is made from 100 percent polyurethane. It is thin, soft, clear and stretchy. When used in the art of sewing it is made to endure every day wear, it retains its strength and elasticity. Also having the ability to withstand 200 degrees Fahrenheit in temperature and adding the durability to stretch three to four times in length. Other material known to persons skilled in the art maybe used.
K. The narrow strip of elastic plastic has two side edges, and two end edges.
L. Taking the narrow strip of elastic and heat sealing the end edge of together to create and elastic plastic band.

Another preferred method of creating the elastic plastic band using elastic plastic narrow strips:

1. Having two narrow strips of elastic plastic
2. Strip one having two side edges, two end edges and is equal in length as strip two
3. Strip two having two side edges, two end edges and is equal in length as strip one
4. Heat sealing strip one's two ends together with strip two's, two ends thus creating an elastic plastic band.
M. The circumference of the top of the liner is larger than the circumference of the elastic plastic band.
N. The elastic plastic band is in a slightly stretched state of two to eight inches or there about. In at least some embodiments, the size of the band in a slightly stretched state is dependent on the size of the liner.
O. Placing the slightly stretched elastic plastic band over the liner's opened exposed top edges, in order to bring the plastic film edges over the elastic plastic band and heat sealing, creating an open hem. Having the elastic plastic band encased as such, it is able to move freely within the hem, ensuring the fit of the perimeter of various geometric shaped trash receptacles or waste baskets or containers.

A circular liner;

In making a circular liner of an embodiment of the present invention.

The method of making at least one embodiment:

In making a circular liner, the body is made from plastic film. Using one elongated rectangular shaped piece of plastic film for the body, it also has an opened top that encases a narrow elastic plastic band, flexible side walls and a bottom that is double in thickness and integral with the liner.

A. A piece of elongated plastic film that has a top side edge, a bottom side edge, and two end edges.
B. Taking the piece of plastic film and folding it in half so that the two end edges meet.
C. Heat sealing the two end edges together creating a top circular edge and a bottom circular edge and a circular film body.
D. There is a bottom piece that is made from the same plastic film. It is shaped in a circle; it is double in thickness, and has circumference edges.
E. Taking the bottom edges of the circular plastic film body and heat sealing at the circular shaped bottom circumference edges, together fully around F. Thus creating a circular liner with flexible side walls and a bottom that is double in thickness and is integral with the liner.
G. Using a narrow strip of clear light weight elastic plastic which is roughly ⅜ inches in width that could be ⅛ inches to 8/8 inches in width there about and added thickness can be used if warranted (used for different sizes and shaped liners). The brand ‘Stretchrite®’ is used in the art of sewing and is made from 100 percent polyurethane. It is thin, soft, clear and stretchy. When used in the art of sewing it is made to endure every day wear, it retains its strength and elasticity. Also having the ability to withstand 200 degrees Fahrenheit in temperature and adding the durability to stretch three to four times in length. Other material known to persons skilled in the art maybe used.
H. The narrow strip of elastic plastic has two side edges, and two end edges.
I. Taking the narrow strip of elastic plastic and heat sealing the end edge together to create an elastic plastic band.

J. The plastic film body's circumference of this plastic liner's top is larger than the circumference of the elastic plastic band.

K. The elastic plastic band is in a stretched state of between two and eight inches or there about

L. Placing the slightly stretched elastic plastic band over the liner's opened top edges in order to bring the plastic film's edges over the elastic plastic band and heat sealing, creating an open hem. Having the elastic plastic band encased as such it is able to move freely within the hem ensuring the fit of the perimeter of various geometric shaped trash receptacle waste baskets or containers.

M. In having the elastic band being thin, light weight, and smooth in texture the elastic plastic band can move freely and easily in the open hem. Also in creating a hem as such at the outer surface of the top circumference of the plastic film liner that is smooth in texture and appealing to the eye where the top perimeter may be seen on the outside of the container of the waste basket, container, or trash receptacle.

N. Having an elastic plastic band in a slightly stretched state in the perimeter of the hem in the circular plastic liner as such, the liner may be inserted in and retained on the trash receptacle, or container or waste basket and fitted snuggly in place.

Another preferred method for making a circular liner:

Concept Design 2 for circular liner that has;

A. Two pieces of plastic film used for the body of the liner
B. Piece one has two side edges, a top edge, a bottom edge and is equal in size as piece two
C. Piece two has two side edges a top edge and a bottom edge and is equal in size to piece one
D. Taking piece one's two side edges and piece two's two side edges and heat sealing them together. Thus creating a circular body with flexible side walls having exposed top edges and exposed bottom edges.
E. A separate bottom that is double in thickness and uses the same plastic film is shaped circular with circumference edges that are equal in the liner body's circumference's edges.
F. Heat sealing the bottom edges of the circular body's circumference to the double thick circular bottom circumference's edges together creating a circular liner, that has a bottom that is double in thickness and integral with the liner.
G. Using a narrow strip of clear light weight elastic plastic which is roughly ⅜ inches in width that could be ⅛ inches to 8/8 inches in width there about and added thickness can be used if warranted (used for different sizes and shaped liners). The brand ‘Stretchrite®’ is used in the art of sewing and is made from 100 percent polyurethane. It is thin, soft, clear and stretchy. When used in the art of sewing it is made to endure every day wear, it retains its strength and elasticity. Also having the ability to withstand 200 degrees Fahrenheit in temperature and adding the durability to stretch three to four times in length. Other material known to persons skilled in the art maybe used.
H. The narrow strip of elastic plastic has two side edges, and two end edges.
I. Taking the narrow strip of elastic and heat sealing the end edge of together to create and elastic plastic band.
J. The top circumference of the plastic liner is greater in size than the elastic plastic band.
K. The elastic plastic band is in a stretched state of between two and eight inches or there about.
L. Placing the slightly stretched elastic plastic band over the liner's opened top edges in order to bring the plastic film's edges over the elastic plastic band and heat sealing; creating an opened hem. Having the elastic plastic band encased as such it is able to move freely within the hem ensuring the fit of the perimeters of the various geometric shaped trash receptacles or waste baskets or containers.
M. Also in having the elastic band being thin, light weight, and smooth in texture the elastic plastic band can move freely and easily in the open hem. Also in creating a hem as such at the outer surface of the top circumference of the plastic film liner that is smooth in texture and appealing to the eye where the top perimeter may be seen on the outside of the container of the waste basket, container, or trash receptacle.
N. Having an elastic plastic band in a slightly stretched state in the perimeter of the hem in the circular plastic liner as such, the liner may be inserted in and retained on the trash receptacle, or container or waste basket and fitted snuggly in place.

The manufacturing procedure described in the present disclosure of a ‘liner’ in which uses plastic film. Using a BioPlastic film in which is made from renewable resources and native plant starches like potatoes, corn, sugar cane, wheat, tapioca, and soy. The BioPlastic film is fully degradable within 10 to 45 days, can control odors, dissipate moisture and is environmentally friendly. Another plastic film could be used in one or more embodiments of the present invention is linear low-density polyethylene (LLPE). This type of plastic film has two main assets (but is not environmentally friendly) #1 the plastic film is stretchy and is resistant to tearing easily. Other materials know to the persons skilled in art may be used.

In dispensing the presently disclosed liners, the plastic film and the plastic elastic band are light weight, flexible, and soft, therefore the liners may be flattened, overlaid one over the other and compressed into a roll or by having the liners folded in a compressed state and packed in a carton or container to be distributed with ease by the consumer.

In one or more embodiments of the present invention, plastic elastic is used to make the liner.

In one or more embodiments of the present invention, the elastic plastic is encased and not connected to the side of the liner.

In one or more embodiments of the present invention, the liner bottoms are shaped and double thickness. In one or more embodiments of the present invention, formed sides are used.

In one or more embodiments of the present invention, the liner can be manufactured to be utilized in various geometrically shaped receptacles.

In one or more embodiments of the present invention, the liner is not perforated, when unrolled they can be overlapped and/or also folded tightly in boxes.

In one or more embodiments of the present invention, a top hem with a smooth top of the liner at its circumference is created so not to take away from the uniqueness of the design of the receptacle.

What is claimed is:

1. In combination with a waste basket or other trash receptacle or container, a liner having a top perimeter and a bottom portion, an elastic means being retained on the top perimeter of the liner and forming a narrow band thereabout, such that the liner may be removably inserted in and retained on the trash receptacle or container and fitted in place within the container, the liner having a transverse cross-section conforming closely to the container, thereby avoiding bulges or gaps between the liner and the container and wherein material deposited in the trash receptacle or container are received in the liner.

2. The combination of claim 1, wherein the liner is color coordinated with the decor of the room in which the trash receptacle or container is disposed.

3. The combination of claim 1, wherein the bottom portion of the liner is an integral planar reinforcement conforming substantially to a base of the trash receptacle or container.

4. A disposable removable liner for a container, the container having surrounding walls, a bottom and an open top, the liner comprising flexible film side walls, a top portion and a bottom portion, the bottom portion having a planar reinforcement and a transverse cross-section conforming closely to the bottom of the container, wherein when the liner is disposed in the container, the side walls of the liner are disposed in the container without bulges or gaps between the side walls of the liner and the walls of the container, an elastic means attached circumferentially about the top portion of the liner wherein when the liner is fitted in the container, the elastic means holds the top portion of the liner to the outer wall of the container, the liner being color coordinated with the decor of the room in which the container is disposed.

5. A method of collecting trash in a waste basket or other trash receptacle or container, wherein the container has a transverse cross-section comprising the steps of providing a disposable liner having a transverse cross-section which substantially conforms to the cross-section of the container, unfolding the liner and inserting the liner into the container, such that the liner, when unfolded, lies neatly within the container without bulges or gaps and conforming to the base of the container, the top of the liner being provided with an elastic band, and the elastic band being snapped over a peripheral lip of the container.
